(19) United States
(12) Patent Application Publication
(10) Pub. No.: US 2019/0071293 A1
(43) Pub. Date: Mar. 7, 2019

(54) METHOD AND SYSTEM FOR A LOW HEIGHT LIFT DEVICE

(71) Applicant: Xtreme Manufacturing, LLC, Henderson, NV (US)

(72) Inventors: Don Francis Ahern, Las Vegas, NV (US); Ronald Lee Fifield, Las Vegas, NV (US)

(21) Appl. No.: 16/182,274

(22) Filed: Nov. 6, 2018

Related U.S. Application Data
(63) Continuation-in-part of application No. 14/164,570, filed on Jan. 27, 2014, now Pat. No. 10,118,810.

(51) Int. Cl. B66F 11/04; B62D 65/02; B66F 13/00

(52) U.S. Cl. CPC B66F 11/042; B66F 13/00; B62D 65/02

(57) ABSTRACT

A scissors lift vehicle includes a chassis, a first pair of wheels disposed at one end of the chassis and a second pair of steering wheels disposed at an opposite end of the chassis. The wheels include a circular profile having a radius R. The scissors lift vehicle includes a track having an upper surface and a lower surface extending aft at a height less than R above the travel surface. A pivot connection is coupled to the aft plate at a height less than R above the travel surface. A scissors stack assembly includes a plurality of paired scissors linkages. Each scissors linkage of a first pair of scissors linkages is coupled to a respective pivot connection. Each scissors linkage of a second pair of scissors linkages includes a truck coupled to a distal end. The truck is configured to engage the upper surface of the track.

### BACKGROUND

This description relates to lift devices, and, more particularly, to an adjustable height man lift and methods of assembling adjustable height man lifts.

Scissors lifts are a type of platform that can usually only be moved in a vertical direction. The lift mechanism is often mounted to a self-propelled carriage or chassis having wheels for moving the platform between work areas. The mechanism to achieve the vertical lift is a plurality of linked, folding supports oriented in a crisscross or “X” pattern. The pattern is also known as a pantograph. The upward motion is achieved by the application of a force to a set of parallel linkages, elongating the crossing pattern, and propelling the work platform vertically. Because scissors lift devices evolved from a device that included a scissors lift assembly mounted on a pulled carriage that was not self-propelled, current scissor lift designs still have the scissors lift assembly mounted on top of a carriage. In self-propelled models, many of the propelling features are mounted under the scissors lift assembly. A hydraulic system, electrical system including batteries, and a control system are also typically mounted on the carriage below the scissors lift assembly. Additionally, axles, steering and transmission components are also mounted on the carriage under the scissors lift assembly. Accordingly, because of the equipment located under the scissors lift assembly on the carriage, the height of the work platform that carries a user to the work area is greatly elevated above the floor surface. To gain access to the work platform of known scissors lift assemblies, the user must climb onto the platform, usually using several ladder steps attached to the carriage and/or platform, and usually carrying tools, equipment, and/or repair parts. Such access is laborious for the user. Moreover, mounting the scissors lift assembly on top of the carriage increases the height of the scissors lift vehicle when the scissors lift assembly is fully retracted. The increased height limits areas that the scissors lift vehicle can access.

### BRIEF DESCRIPTION OF THE DISCLOSURE

In one aspect, a scissors lift vehicle includes a chassis formed of a pair of parallelly-oriented channels. Each channel includes a first forward end and a second aft end. The first forward ends of each of channel are coupled together using a forward plate extending orthogonally between the first forward ends. The second aft ends of each of the channels are coupled together using an aft plate extending orthogonally between the second aft ends and parallel to the forward plate. The scissors lift vehicle also includes a first pair of wheels disposed at one end of the chassis and a second pair of steering wheels disposed at an opposite end of the chassis. The wheels are configured to roll along a travel surface and include a circular profile having a radius R. Each wheel of each pair of wheels is spaced apart laterally with respect to the other wheel of the pair. The pairs of wheels are spaced apart longitudinally from the other pair of wheels. The scissors lift vehicle includes a track including an upper surface, a lower surface and a thickness extending therebetween, the track extending aft at a height less than R above the travel surface from the forward plate parallel to the pair of channels and a pivot connection coupled to the aft plate at a height less than R above the travel surface. A scissors stack assembly includes a plurality of paired scissors linkages extendable from a retracted position to an extended position. Each scissors linkage of a first pair of scissors linkages of the plurality of paired scissors linkages is pivotally coupled to a respective pivot connection. Each scissors linkage of a second pair of scissors linkages of the plurality of paired scissors linkages includes a truck coupled to a distal end of each scissors linkage of the second pair of scissors linkages. The truck is configured to engage the upper surface of the track.

In another aspect, a method of assembling a scissors lift vehicle includes providing a chassis having an opening formed between a pair of parallelly oriented side channels and coupling a first pair of wheels to one end of the chassis and a second pair of steering wheels to an opposite end of the chassis. The wheels are configured to roll along a travel surface and each wheel includes a circular profile having a radius R. The method also includes coupling a pivot connection the end of the chassis at a height less than R above the travel surface and coupling a track, having an upper surface, a lower surface and a thickness extending therebetween, to the opposite end of the chassis. The track extends aft at a height less than R above the travel surface. The method further includes coupling a scissors stack assembly to the chassis within the opening. The scissors stack assembly including a plurality of paired scissors linkages, each scissors linkage of a first pair of scissors linkages of the plurality of paired scissors linkages, pivotally coupled to a respective pivot connection, each scissors linkage of a second pair of scissors linkages of the plurality of paired scissors linkages including a truck coupled to a distal end of each scissors linkage of the second pair of scissors linkages. The truck configured to engage the upper surface of the track.

In yet another aspect, a scissors lift vehicle includes a chassis, a first pair of wheels disposed at one end of the chassis and a second pair of steering wheels disposed at an opposite end of the chassis. The wheels are configured to roll along a travel surface and each wheel has a circular profile having a radius R. A track includes an upper surface, a lower surface and a thickness extending therebetween. The track extends longitudinally from one end of the chassis within an opening of the chassis at a height less than R above the travel surface. A pivot connection is coupled to the opposite end of the chassis at a height less than R above the travel surface. The scissors lift vehicle also includes a scissors stack assembly positioned within the opening and including a plurality of paired scissors linkages. Each scissors linkage of a first pair of scissors linkages of the plurality of paired scissors linkages is pivotally coupled to a respective pivot connection. Each scissors linkage of a second pair of scissors linkages of the plurality of paired scissors linkages includes a truck coupled to a distal end of each scissors linkage of the second pair of scissors linkages. The truck is configured to engage the upper surface of the track.

### BRIEF DESCRIPTION OF THE DRAWINGS

FIGS. 1-11 show example embodiments of the method and apparatus described herein.

FIG. 1 is a side elevation view of a scissors lift vehicle in accordance with an example embodiment of the present disclosure.

FIG. 2 is a front elevation view of scissors lift vehicle in accordance with the example embodiment of the present disclosure.

FIG. 3 is a side elevation view of a portion of the scissors lift vehicle illustrating the scissors stack assembly including a plurality of scissors linkages pivotally coupled together.

FIG. 4 is another side elevation view of the scissors lift vehicle.

FIG. 5 is a side view of truck.

FIG. 6 is a forward view looking aft of truck.

FIG. 7 is a plan view of a forward section of the chassis shown in FIG. 3.

FIG. 8 is a perspective view of the forward section of the chassis shown in FIG. 7.

FIG. 9 is a plan view of an aft section of the chassis.

FIG. 10 is another plan view of an aft section of the chassis.

FIG. 11 is a flow chart of a method of assembling the scissors lift vehicle.

Although specific features of various embodiments may be shown in some drawings and not in others, this is for convenience only. Any feature of any drawing may be referenced and/or claimed in combination with any feature of any other drawing.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION OF THE DISCLOSURE

The following detailed description illustrates embodiments of the disclosure by way of example and not by way of limitation. It is contemplated that the disclosure has general application to embodiments of a scissors lift vehicle and a method of assembling a scissors lift vehicle.

In the example embodiment, the scissors lift vehicle includes a chassis including a pair of parallelly oriented structural members or channels. Each channel includes a first forward end and a second aft end. The first forward ends of each of the channels are coupled together using a forward plate extending orthogonally between the first forward ends. The second aft ends of each of the channels are coupled together using an aft plate extending orthogonally between the second aft ends and parallel to the forward plate.

The scissors lift vehicle also includes a first pair of wheels positioned at one end of the chassis and a second pair of steering wheels positioned at an opposite end of the chassis. In some embodiments, at least one of the second pair of steering wheels are drive wheels configured to propel the scissors lift vehicle using a propulsion motor. The propulsion motor includes at least one of an electric motor and a hydraulic motor. The wheels are configured to roll along a travel surface and include a circular profile having a radius R. In various embodiments, the first pair of wheels includes follower wheels. Each wheel of each pair of wheels are spaced apart laterally with respect to the other wheel of the pair. The pairs of wheels are spaced apart longitudinally from the other pair of wheels.

The scissors lift vehicle further includes a track including an upper surface, a lower surface and a thickness extending therebetween. The track extends aft at a height less than R above the travel surface from the forward plate parallel to the pair of channels. A pivot connection is coupled to the aft plate at a height less than R above the travel surface.

The scissors lift vehicle also includes a scissors stack assembly including a plurality of paired scissors linkages extendable from a retracted position to an extended position. Each scissors linkage of a first pair of scissors linkages of the plurality of paired scissors linkages is pivotally coupled to a respective pivot connection. Each scissors linkage of a second pair of scissors linkages of the plurality of paired scissors linkages includes a truck coupled to a distal end of each scissors linkage of the second pair of scissors linkages. The truck is configured to engage the upper surface of the track.

Each truck optionally includes an inner support plate, an outer support plate, and a roller assembly extending therebetween. A linkage connection is configured to couple to the distal end of a respective scissors linkage of the second pair of scissors linkages. A track keeper includes a body extending from at least one of the inner support plate and the outer support plate to face to face proximity to the lower surface.

Optionally, the scissors lift vehicle also includes a third pair of scissors linkages joined by a lower hydraulic cylinder coupling member extending between the third pair of scissors linkages and a fourth pair of scissors linkages joined by an upper hydraulic cylinder coupling member extending between the fourth pair of scissors linkages. The scissors stack assembly further includes a hydraulic cylinder operatively coupled between the lower hydraulic cylinder coupling member and the upper hydraulic cylinder coupling member. In various embodiments, the third pair of scissors linkages and the fourth pair of scissors linkages are parallel with respect to each other.

The following description refers to the accompanying drawings, in which, in the absence of a contrary representation, the same numbers in different drawings represent similar elements.

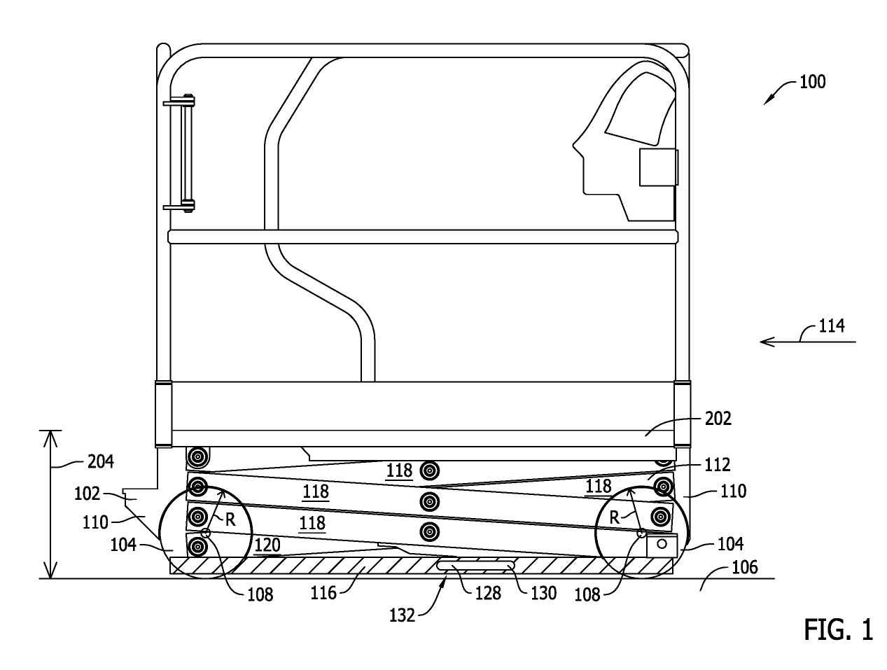

FIG. 1 is a side elevation view of a scissors lift vehicle 100 in accordance with an example embodiment of the present disclosure. In the example embodiment, scissors lift vehicle 100 includes a carriage 102 that includes a plurality of independently steerable wheels 104, each configured to engage a travel surface 106 during operation of scissors lift vehicle 100. Travel surface 106 could be an asphalt surface in an outdoor application of scissors lift vehicle 100 or may be concrete, wood, carpet, tile, or other surface in an indoor application of scissors lift vehicle 100. Wheels 104 are configured to rotate about an axis of rotation 108 and may be powered by a dedicated motor (not shown) coupled directly to each wheel 104. Wheels include a circular profile having a radius R and are spaced apart from each other along an underside of carriage 102. Typically, one wheel 104 is positioned at or near each corner 110 of rectangularly-shaped carriage 102. In various embodiments, wheels 104 are spaced as far as possible to improve the stability of scissors lift vehicle 100, especially when a scissors stack assembly 112 is extended. In various embodiments, more than four wheels 104, one at each corner 110 may be used. Additionally, carriage 102 may not be rectangularly-shaped, but may have other shapes, where additional wheels 104 could be used. Wheels 104 may be spaced apart in a fore/aft direction 114 and in a right/left or lateral direction (i.e., into or out of the page). Wheels 104 may be spaced from each other unequal distances apart, for example, a track of the fore wheels may be wider or narrower than the track of the aft wheels.

A base 116 is coupled to or formed with carriage 102 between wheels 104 spaced apart in the right/left direction and is positioned vertically such that base 116 lies within a profile of wheels 104. For example, if wheels 104 are twelve inches in diameter, base 116 is positioned vertically less than twelve inches above the lowest extent of wheels 104, which, in most cases, would be the equivalent of being less than twelve inches above travel surface 106. Accordingly, in some embodiments, base 116 may be located less than 2R above travel surface 106 during operation of scissors lift vehicle 100 and in other embodiments base 116 may be located less than R above travel surface 106 during operation of scissors lift vehicle 100.

In the example embodiment, scissors stack assembly 112 includes a plurality of scissors linkages 118 pivotally coupled together and extendable from a retracted position (shown in FIG. 1), where the scissors linkages are approximately horizontally configured to an extended position (not shown in FIG. 1), where the scissors linkages are approximately orthogonally configured with respect to each other. Scissors stack assembly 112 is pivotally coupled to base 116 through a first pair of scissors linkages 120 and 122 (122 is hidden behind 120 in FIG. 1) and is slidably coupled to base 116 through a second pair of scissors linkages, 124 and 126 (126 is hidden behind 124 in FIG. 1). Base 116 includes a slot 128 configured to receive a pin 130. Base 116 and first pair of scissors linkages 120 and 122 are coupled in a pivotal joint (not shown in FIG. 1). Base 116 and second pair of scissors linkages 124 and 126 are coupled in a slidable joint 132 using slot 128 and pin 130. Pivotal joint 132 and the slidable joint are located between wheels 104 spaced apart in the right/left direction and within a profile of wheels 104.

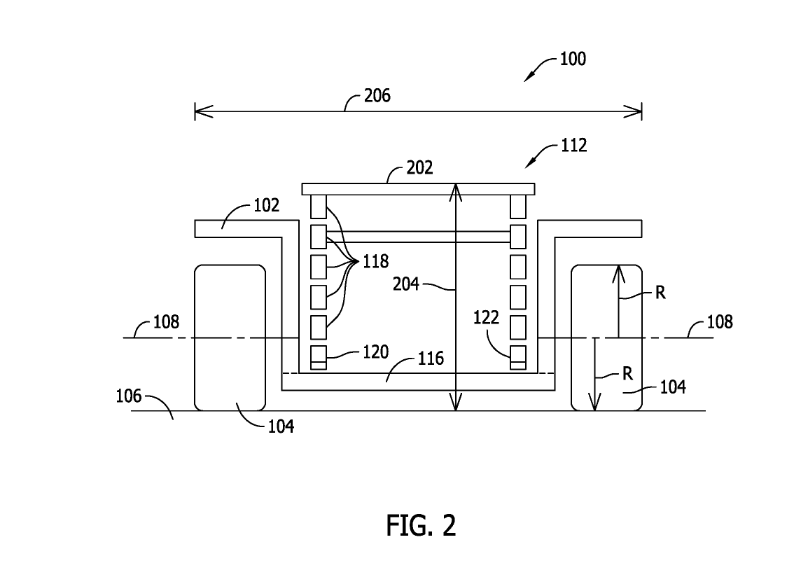

FIG. 2 is a front elevation view of scissors lift vehicle 100 in accordance with the example embodiment of the present disclosure. In the example embodiment, scissors lift vehicle 100 includes base 116 positioned below axis 108 such that base is less than R distance above travel surface 106. Such a position permits scissors stack assembly 112 to be positioned lower in relation to travel surface 106 than other known scissors lift vehicles. Accordingly, a deck 202 is mounted to scissors stack assembly 112 at a relatively lower height 204 above travel surface 106. Height 204 is configured to conform to a standard step height of a user for entry onto deck 202 directly from travel surface 106 without intermediate stepping surfaces, such as, steps, stairs, or pegs. In the example embodiment, a standard step height of about 20.0 inches is contemplated based on ANSI/SIA A92.6-2006. Other step heights may be selected based on local custom or other regulations. A width 206 of carriage 102 is configured to fit within an interior door frame of, for example, but, not limited to, an office, a home, or a commercial building.

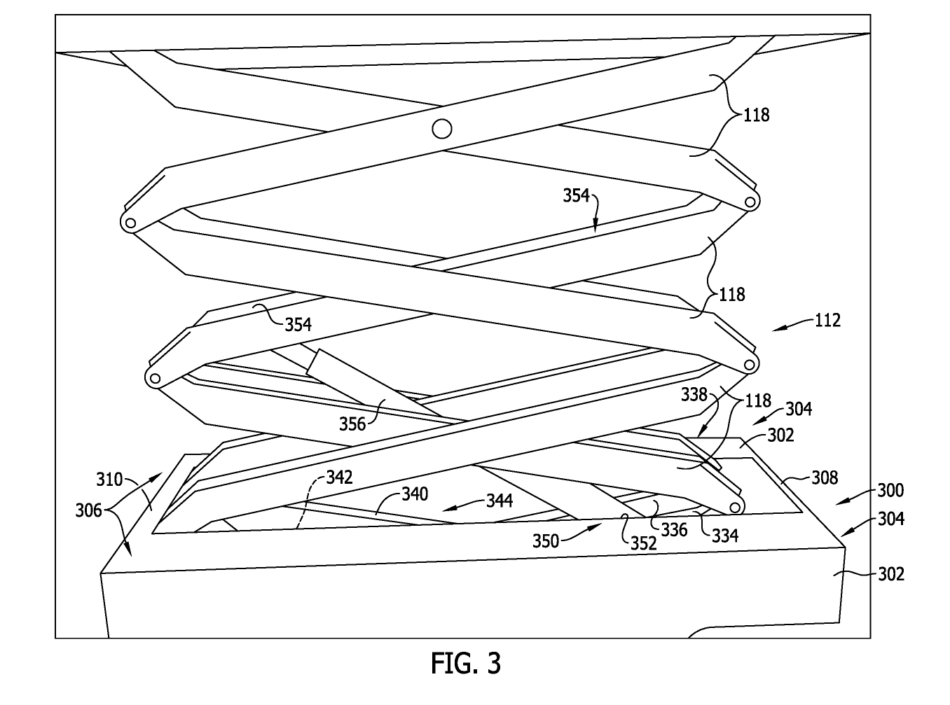

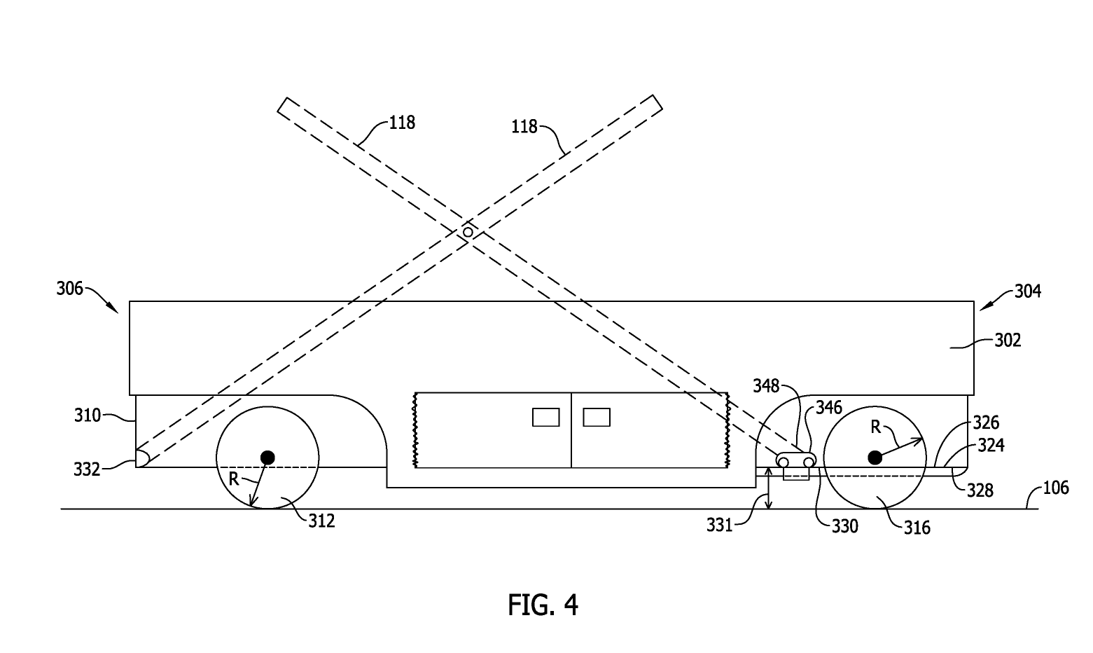

FIG. 3 is a side elevation view of a portion of scissors lift vehicle 100 illustrating scissors stack assembly 112 including a plurality of scissors linkages 118 pivotally coupled together. FIG. 4 is another side elevation view of scissors lift vehicle 100. Scissors lift vehicle 100 includes a chassis 300 including a pair of parallelly oriented structural members or channels 302. Each channel 302 includes a first forward end 304 and a second aft end 306. First forward ends 304 of each of channels 302 are coupled together using a forward plate 308 extending orthogonally between first forward ends 304. Second aft ends 306 of each of channels 302 are coupled together using an aft plate 310 extending orthogonally between second aft ends 306 and parallel to forward plate 308.

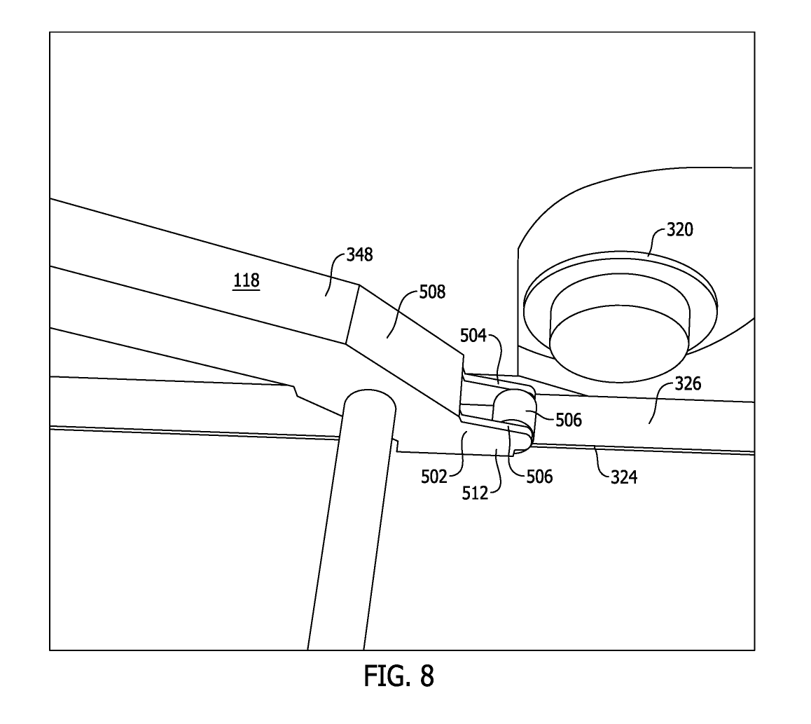

Scissors lift vehicle 100 also includes a first pair of wheels 312 positioned at one end 314 of chassis 300 and a second pair of steering wheels 316 positioned at an opposite end 318 of chassis 300. In some embodiments, at least one of second pair of steering wheels 316 are drive wheels configured to propel scissors lift vehicle using a propulsion motor 320. Propulsion motor 320 includes at least one of an electric motor and a hydraulic motor. Wheels 312, 316 are configured to roll along travel surface 106 and include a circular profile 324 having a radius R. In various embodiments, first pair of wheels 312 are embodied as follower wheels that may be supported by separate axles 325 (shown in FIG. 8). Each wheel of each pair of wheels 312, 316 is spaced apart laterally with respect to the other wheel 312, 316 of the pair. The pairs of wheels 312, 316 are spaced apart longitudinally from the other pair of wheels 312, 316.

Scissors lift vehicle 100 further includes a track 324 including an upper surface 326, a lower surface 328, and a thickness 330 extending therebetween. Track 324 extends aft at a height 331 less than R above travel surface 106 from forward plate 308 parallel to pair of channels 302. A pivot connection 332 is coupled to aft plate 310 at a height less than R above travel surface 106.

Scissors lift vehicle 100 also includes scissors stack assembly 112 including a plurality of paired scissors linkages 118 extendable from a retracted position to an extended position. Each scissors linkage 334, 336 of a first pair of scissors linkages 338 of plurality of paired scissors linkages 118 is pivotally coupled to a respective pivot connection 332. Each scissors linkage 340, 342 of a second pair of scissors linkages 344 of plurality of paired scissors linkages 118 includes a truck 346 coupled to a distal end 348 of each scissors linkage 340, 342 of second pair of scissors linkages 344. Truck 346 is configured to engage upper surface 326 of track 324.

Optionally, scissors lift vehicle 100 also includes a third pair of scissors linkages 350 (In the example embodiment, first pair 338 and third pair 350 are the same pair, but this does not need to be the case) joined by a lower hydraulic cylinder coupling member 352 extending between third pair of scissors linkages 350 and a fourth pair of scissors linkages 352 joined by an upper hydraulic cylinder coupling member 354 extending between fourth pair of scissors linkages 352. Scissors stack assembly 112 further includes a hydraulic cylinder assembly 356 operatively coupled between lower hydraulic cylinder coupling member 352 and upper hydraulic cylinder coupling member 354. In various embodiments, third pair of scissors linkages 350 and fourth pair of scissors linkages 352 are parallel with respect to each other.

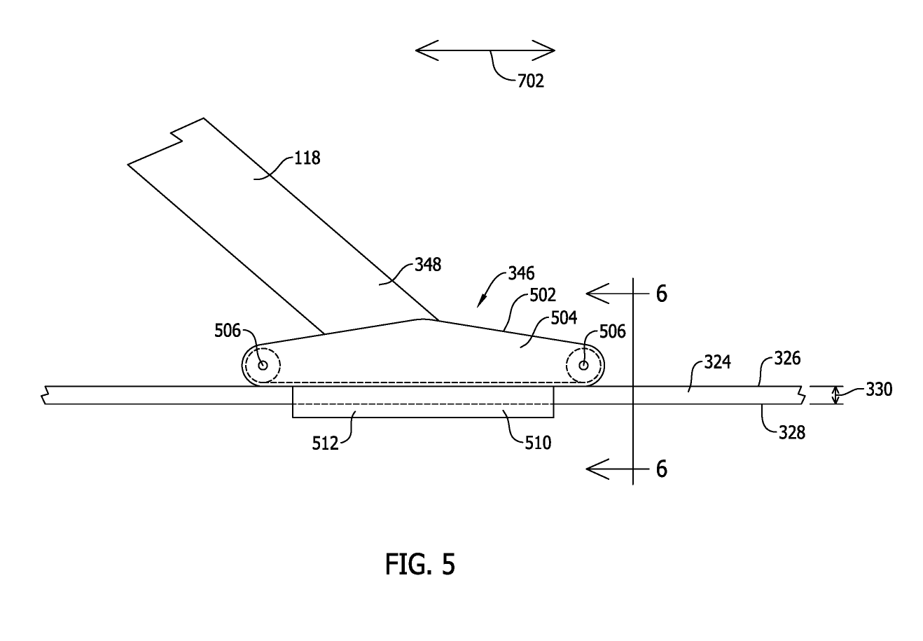

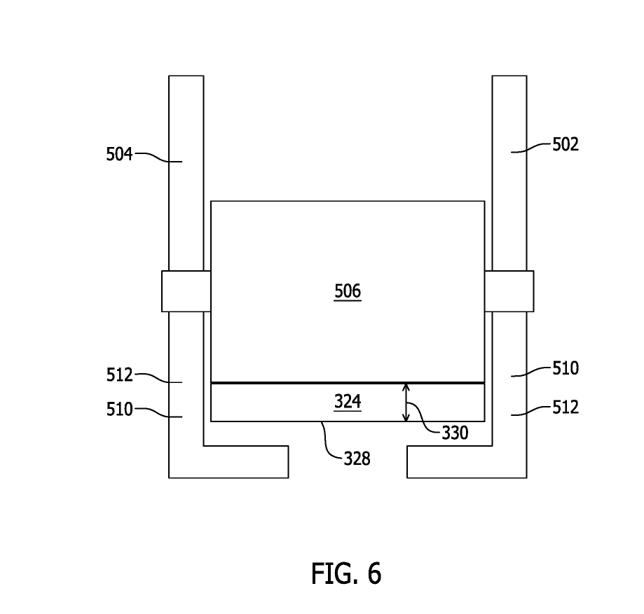

FIG. 5 is a side view of truck 346. FIG. 6 is a forward view looking aft of truck 346. Each truck 346 optionally includes an inner support plate 502, an outer support plate 504, and a roller assembly 506 extending therebetween. A linkage connection 508 is configured to couple to distal end 348 of a respective scissors linkage of second pair of scissors linkages. A track keeper 510 includes a body 512 extending from at least one of inner support plate 502 and outer support plate 504 to face to face proximity to lower surface 528.

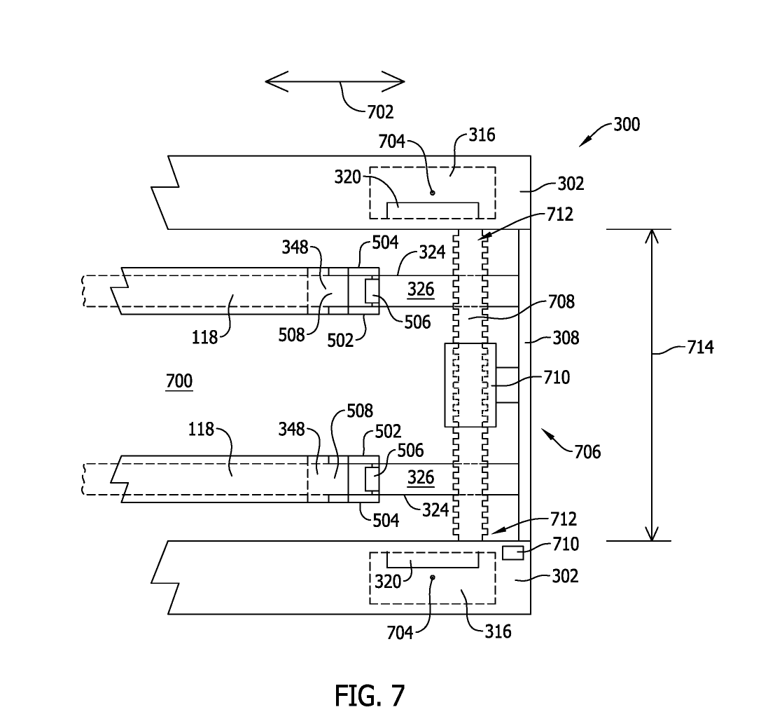

FIG. 7 is a plan view of a forward section of chassis 300. FIG. 8 is a perspective view of the forward section of chassis 300 (shown in FIG. 7). Between channels 302 an opening 700 is formed to permit positioning scissors stack assembly 112 within chassis 300. Track 326 extends aft from forward plate 308 or other support member configured to support track 326. Truck 346 rolls on track 326 to permit translation of distal end 348 in a longitudinal direction 702.

Second pair of steering wheels are rotated around a kingpin 704 for steerage using a steering linkage 706 that, in some embodiments, includes a leadscrew drive 708. In various embodiments, leadscrew steering linkage 706 is powered by an actuator 710 that includes at least one of a hydraulic actuator and an electric actuator. Actuator 710 may be positioned proximate an end 712 of leadscrew drive 708 or along a length 714 of leadscrew drive 708.

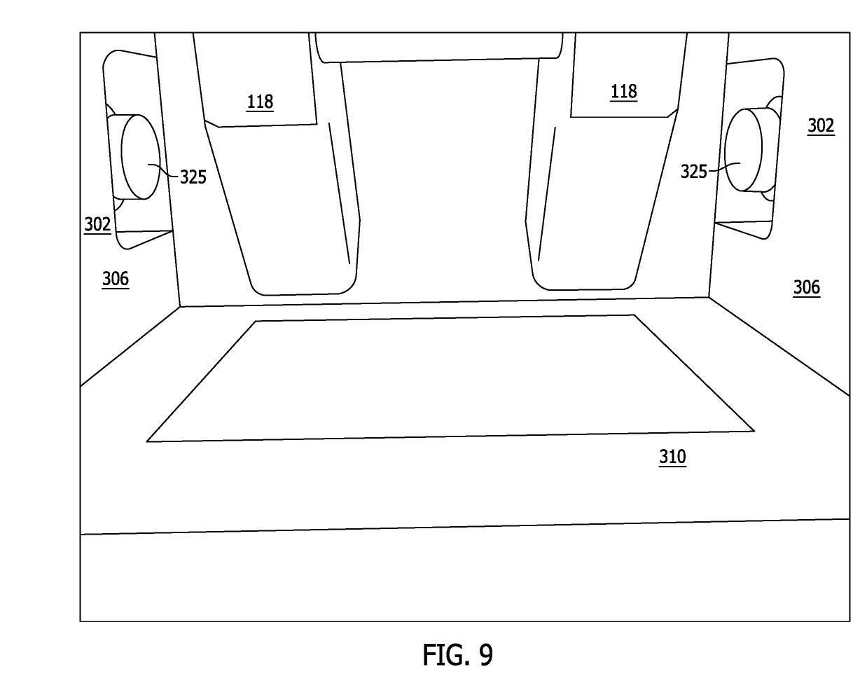

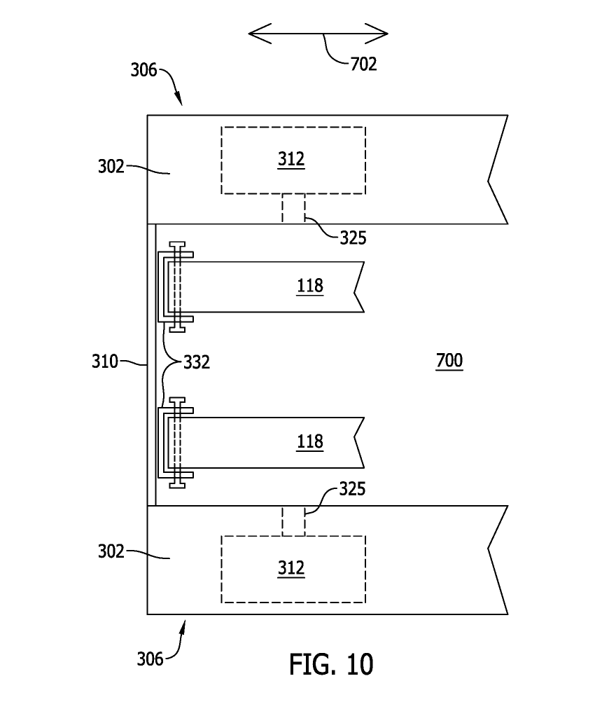

FIG. 9 is a plan view of an aft section of chassis 300. FIG. 10 is another plan view of an aft section of chassis 300. In the example embodiment, pivot connection 332 is coupled to aft plate 310 at a height less than R above travel surface 106.

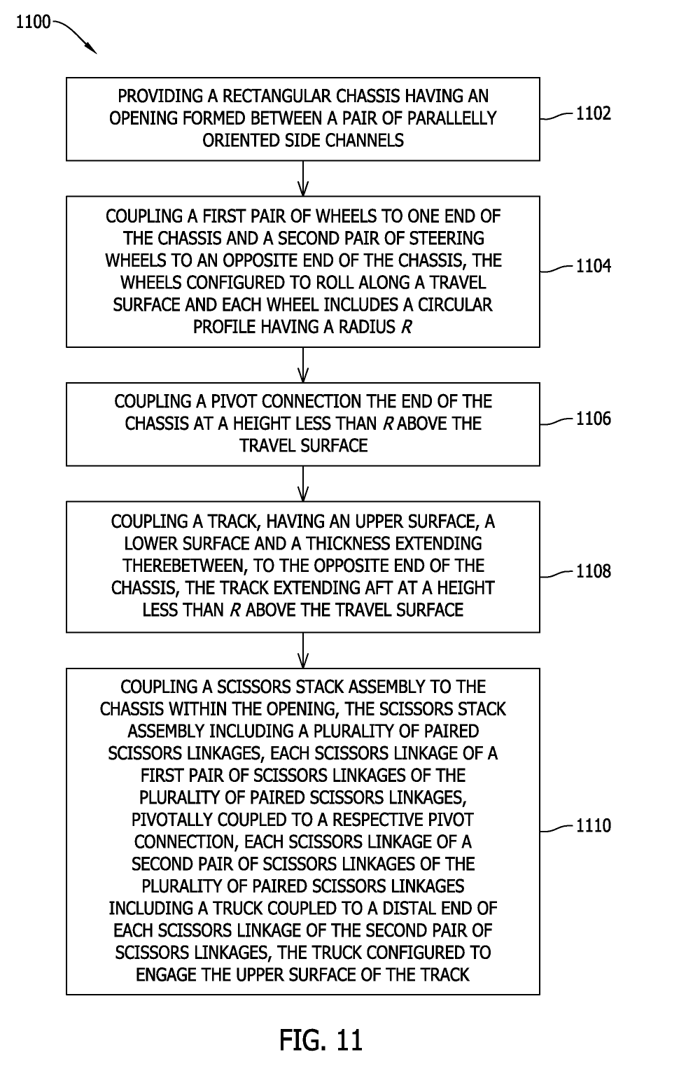

FIG. 11 is a flow chart of a method 1100 of assembling a scissors lift vehicle. In the example embodiment, method 1100 includes providing 1102 a rectangular chassis having an opening formed between a pair of parallelly oriented side channels and coupling 1104 a first pair of wheels to one end of the chassis and a second pair of steering wheels to an opposite end of the chassis. The wheels are configured to roll along a travel surface and each wheel includes a circular profile having a radius R. In various embodiments, the travel surface may be a smooth surface such as, but not limited to an asphalt roadway or parking lot, or a paved surface such as, but not limited to a convention center floor. In some embodiments, the travel surface may be a rough surface including loose rock or gravel and unevenness. In the example embodiment, the first pair of wheels is embodied in a pair of follower wheels. The pair of steering wheels may also be drive wheels coupled to a propulsion motor configured to propel the scissors lift vehicle along the travel surface. The propulsion motor may be an electric motor or a hydraulic motor.

Method 1100 includes coupling 1106 a pivot connection the end of the chassis at a height less than R above the travel surface and coupling 1108 a track, having an upper surface, a lower surface, and a thickness extending therebetween, to the opposite end of the chassis. The track extends aft at a height less than R above the travel surface. Method 1100 includes coupling 1110 a scissors stack assembly to the chassis within the opening. The scissors stack assembly includes a plurality of paired scissors linkages. Each scissors linkage of a first pair of scissors linkages of the plurality of paired scissors linkages, pivotally coupled to a respective pivot connection, each scissors linkage of a second pair of scissors linkages of the plurality of paired scissors linkages including a truck coupled to a distal end of each scissors linkage of the second pair of scissors linkages, the truck configured to engage the upper surface of the track. The truck serves to permit longitudinal movement of the scissors linkage to permit extension and retraction of the scissors stack assembly. The truck includes rolling elements to effect the longitudinal translation of the scissors linkage and a keeper to maintain the position of the truck on the track. The truck may be formed by providing an inner support plate, an outer support plate, and a roller assembly extending therebetween, and coupling a linkage connection to the truck assembly. The linkage connection is configured to couple to a distal end of a respective scissors linkage of the second pair of scissors linkages. The truck is further formed by coupling a track keeper having a body extending from at least one of the inner support plate and the outer support plate into face-to-face proximity to the lower surface of the track.

Method 1100 may optionally include coupling a third pair of scissors linkages together using a lower hydraulic cylinder coupling member extending between the third pair of scissors linkages and coupling a fourth pair of scissors linkages using an upper hydraulic cylinder coupling member extending between the fourth pair of scissors linkages. The scissors stack assembly further includes a hydraulic cylinder operatively coupled between the lower hydraulic cylinder coupling member and the upper hydraulic cylinder coupling member. In various embodiments, the third pair of scissors linkages and the fourth pair of scissors linkages are parallel with respect to each other.

The process flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

The above-described embodiments of a method and system of a scissors lift vehicle provide a cost-effective and reliable means of lifting workers to an elevated work site. More specifically, the methods and systems described herein facilitate a worker's ingress and egress to a work platform coupled to a scissors lift assembly portion of the scissors lift vehicle. In addition, the above-described methods and systems facilitate accessing narrow portals to work areas. As a result, the methods and systems described herein facilitate worker safety and work site access in a cost-effective and reliable manner.

This written description uses examples to describe the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A scissors lift vehicle comprising:
a chassis comprising a pair of parallelly oriented channels, each channel comprising a first forward end and a second aft end, said first forward ends of each of said channels coupled together using a forward plate extending orthogonally between said first forward ends, said second aft ends of each of said channels coupled together using an aft plate extending orthogonally between said second aft ends and parallel to said forward plate;
a first pair of wheels disposed at one end of said chassis and a second pair of steering wheels disposed at an opposite end of said chassis, the wheels configured to roll along a travel surface and comprising a circular profile having a radius R, each wheel of each pair of wheels spaced apart laterally with respect to the other wheel of the pair, the pairs of wheels spaced apart longitudinally from the other pair of wheels;
a track comprising an upper surface, a lower surface and a thickness extending therebetween, said track extending aft at a height less than R above the travel surface from said forward plate parallel to said pair of channels;
a pivot connection coupled to said aft plate at a height less than R above the travel surface; and
a scissors stack assembly comprising a plurality of paired scissors linkages extendable from a retracted position to an extended position, each scissors linkage of a first pair of scissors linkages of the plurality of paired scissors linkages, pivotally coupled to a respective pivot connection, each scissors linkage of a second pair of scissors linkages of the plurality of paired scissors linkages comprising a truck coupled to a distal end of each scissors linkage of said second pair of scissors linkages, said truck configured to engage said upper surface of said track.

2. The scissors lift vehicle of claim 1, wherein each said truck comprises:
an inner support plate, an outer support plate, and a roller assembly extending therebetween;
a linkage connection configured to couple to said distal end of a respective scissors linkage of said second pair of scissors linkages; and
a track keeper comprising a body extending from at least one of said inner support plate and said outer support plate to face-to-face proximity to said lower surface.

3. The scissors lift vehicle of claim 1, wherein a third pair of scissors linkages are joined by a lower hydraulic cylinder coupling member extending between said third pair of scissors linkages, a fourth pair of scissors linkages are joined by an upper hydraulic cylinder coupling member extending between said fourth pair of scissors linkages, said scissors stack assembly further comprising a hydraulic cylinder operatively coupled between said lower hydraulic cylinder coupling member and said upper hydraulic cylinder coupling member.

4. The scissors lift vehicle of claim 3, wherein said third pair of scissors linkages and said fourth pair of scissors linkages are parallel with respect to each other.

5. The scissors lift vehicle of claim 1, wherein said first pair of wheels comprise follower wheels.

6. The scissors lift vehicle of claim 1, wherein at least one of said second pair of steering wheels are drive wheels configured to propel said scissors lift vehicle using a propulsion motor.

7. The scissors lift vehicle of claim 6, wherein said propulsion motor comprises at least one of an electric motor and a hydraulic motor.

8. A method of assembling a scissors lift vehicle, the method comprising:
providing a chassis having an opening formed between a pair of parallelly oriented side channels;
coupling a first pair of wheels to one end of the chassis and a second pair of steering wheels to an opposite end of the chassis, the wheels configured to roll along a travel surface and each wheel includes a circular profile having a radius R;
coupling a pivot connection the end of the chassis at a height less than R above the travel surface;
coupling a track, having an upper surface, a lower surface and a thickness extending therebetween, to the opposite end of the chassis, the track extending aft at a height less than R above the travel surface; and
coupling a scissors stack assembly to the chassis within the opening, the scissors stack assembly including a plurality of paired scissors linkages, each scissors linkage of a first pair of scissors linkages of the plurality of paired scissors linkages, pivotally coupled to a respective pivot connection, each scissors linkage of a second pair of scissors linkages of the plurality of paired scissors linkages including a truck coupled to a distal end of each scissors linkage of the second pair of scissors linkages, the truck configured to engage the upper surface of the track.

9. The method of claim 8, further comprising forming the truck by the steps of:
providing a truck assembly including an inner support plate, an outer support plate, and a roller assembly extending therebetween;
coupling a linkage connection to the truck assembly, the linkage connection configured to couple to said distal end of a respective scissors linkage of said second pair of scissors linkages; and
coupling a track keeper comprising a body extending from at least one of the inner support plate and the outer support plate to face-to-face proximity to the lower surface.

10. The method of claim 8, further comprising coupling a third pair of scissors linkages together using a lower hydraulic cylinder coupling member extending between the third pair of scissors linkages and coupling a fourth pair of scissors linkages using an upper hydraulic cylinder coupling member extending between said fourth pair of scissors linkages, the scissors stack assembly further including a hydraulic cylinder operatively coupled between the lower hydraulic cylinder coupling member and the upper hydraulic cylinder coupling member.

11. The method of claim 10, further comprising coupling the hydraulic cylinder between the third pair of scissors linkages and the fourth pair of scissors linkages that are parallel with respect to each other.

12. The method of claim 8, wherein coupling a first pair of wheels to one end of the chassis comprises coupling a first pair of follower wheels to one end of the chassis.

13. The method of claim 8, wherein coupling a second pair of steering wheels to an opposite end of the chassis comprises coupling the second pair of wheels to a propulsion motor configured to propel the scissors lift vehicle along the travel surface.

14. The method of claim 8, wherein coupling the second pair of wheels to a propulsion motor comprises coupling the second pair of wheels to at least one of an electric motor and a hydraulic motor.

15. The method of claim 8, wherein coupling a scissors stack assembly to the chassis within the opening comprises coupling a scissors stack assembly that includes a plurality of scissors linkages extendable from a retracted position to an extended position.

16. A scissors lift vehicle comprising:
a chassis;
a first pair of wheels disposed at one end of said chassis and a second pair of steering wheels disposed at an opposite end of said chassis, the wheels configured to roll along a travel surface and each comprising a circular profile having a radius R;
a track comprising an upper surface, a lower surface and a thickness extending therebetween, said track extending longitudinally from one end of said chassis within an opening of said chassis at a height less than R above the travel surface;
a pivot connection coupled to the opposite end of said chassis at a height less than R above the travel surface; and
a scissors stack assembly positioned within the opening and comprising a plurality of paired scissors linkages, each scissors linkage of a first pair of scissors linkages of the plurality of paired scissors linkages, pivotally coupled to a respective pivot connection, each scissors linkage of a second pair of scissors linkages of the plurality of paired scissors linkages comprising a truck coupled to a distal end of each scissors linkage of said second pair of scissors linkages, said truck configured to engage said upper surface of said track.

17. The scissors lift vehicle of claim 16, wherein said first pair of wheels comprise independent follower wheels.

18. The scissors lift vehicle of claim 17, wherein said follower wheels are supported by separate axles.

19. The scissors lift vehicle of claim 16, wherein said second pair of steering wheels are rotated around a kingpin for steerage using a leadscrew steering linkage.

20. The scissors lift vehicle of claim 19, wherein said leadscrew steering linkage is powered by at least one of hydraulic actuator and an electric actuator.
